(19) United States
(12) Patent Application Publication
(10) Pub. No.: US 2005/0098666 A1
(43) Pub. Date: May 12, 2005

(54) Water sprayer assembly

(76) Inventor: King Yuan Wang, Changhua (TW)

Correspondence Address: WANG KING YUAN, P.O. BOX 487, Changhua City, 500, TW

(21) Appl. No.: 10/752,813

(22) Filed: Jan. 8, 2004

(30) Foreign Application Priority Data
Oct. 30, 2003 (DE) 203 16 814.3

(51) Int. Cl. B05B 7/02

(52) U.S. Cl. 239/600; 239/532; 239/589; 239/525; 239/530; 239/552

(57) ABSTRACT

A water sprayer assembly includes a threaded fitting having a threaded outer periphery and a passage is defined through the threaded fitting. A first end of the threaded fitting has an enlarged first end and a knurl surface is defined in an inner periphery of the passage. The threaded fitting is connected to a sprayer head. A pipe has a first end extending through the passage of the threaded fitting and being in flush with a second end of the threaded fitting. An outer surface of the pipe is securely pressed on the knurl surface of the threaded fitting.

### FIELD OF THE INVENTION

The present invention relates to a water sprayer assembly wherein the threaded fitting includes knurl inside to securely connect the aluminum pipe which has a enlarged end to securely connected to the threaded fitting.

### BACKGROUND OF THE INVENTION

A conventional water spray assembly known to applicant is disclosed in U.S. Pat. No. 6,471,147 which discloses a threaded fitting having a groove defined in an inside thereof and the pipe has a flange-like portion which is engaged with the groove so as to position the end of the pipe in the threaded fitting. Nevertheless, the disclosed involves an inherent shortcoming which is that the thickness of the pipe is only 0.9 mm to 1.0 mm so that the flange-like portion is only a small bump portion which cannot be securely engaged with the groove. Besides, the outer surface of the flange-like portion and the inside of the groove are made to be smooth so that the friction between the two surfaces is much less than expected so that the pipe can easily disengage from the threaded fitting. In other words, in practical use, when pulling the pipe, it is possible to pull the pipe from the threaded fitting. Therefore, adhesive has to be used to further secure the connection of the pipe and the threaded fitting.

### SUMMARY OF THE INVENTION

The present invention relates to a water sprayer assembly which comprises a sprayer head having a first end which includes a section of threaded inner periphery and a flange extends inward from an inner periphery of the first end of the sprayer head. A threaded fitting has a threaded outer periphery so as to be connected to the threaded inner periphery of the sprayer head. A passage is defined through the threaded fitting. A first end of the threaded fitting has an enlarged first end and a knurl surface is defined in an inner periphery of the passage. A pipe has a first end extending through the passage of the threaded fitting from the enlarged first end an outer surface of the pipe is securely pressed on the knurl surface of the threaded fitting.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view showing the threaded fitting and the pipe of the present invention;

FIG. 2 is a cross sectional view showing the connection of the threaded fitting and the pipe;

FIG. 3 is a cross sectional view showing the threaded fitting;

FIG. 4 is an exploded view shown the water sprayer assembly of the present invention;

FIG. 5 is a cross sectional view showing the water sprayer assembly of the present invention, and

FIG. 6 shows the connection of the threaded fitting and the pipe wherein the first end of the pipe is in flush with the threaded fitting.

### DETAILED DESCRIPTION OF THE PREFERRED EMBODIMENT

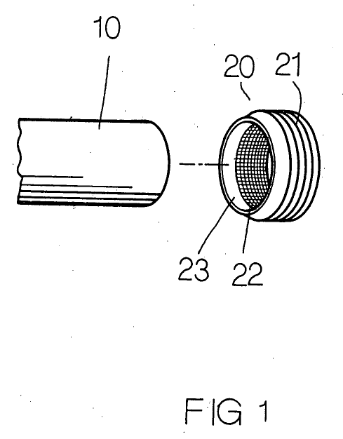

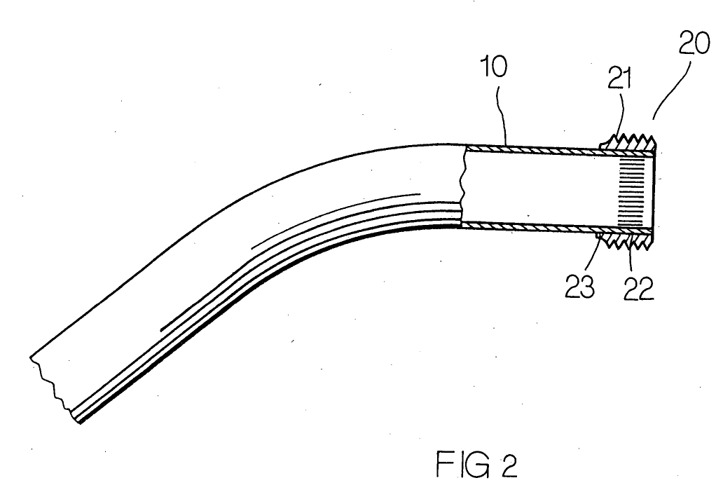

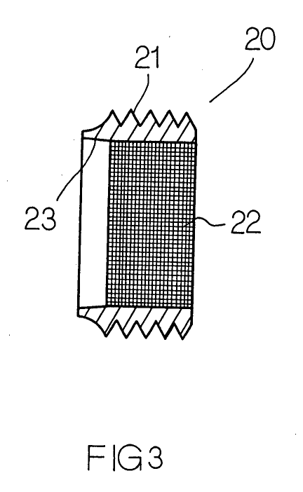

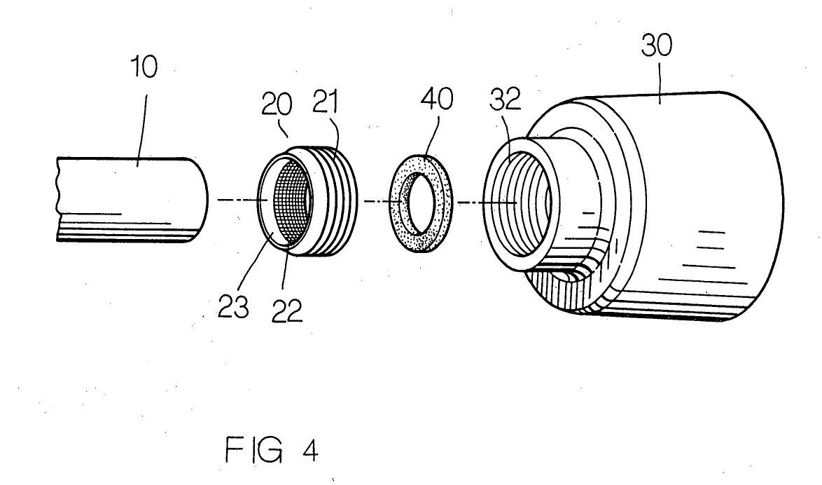

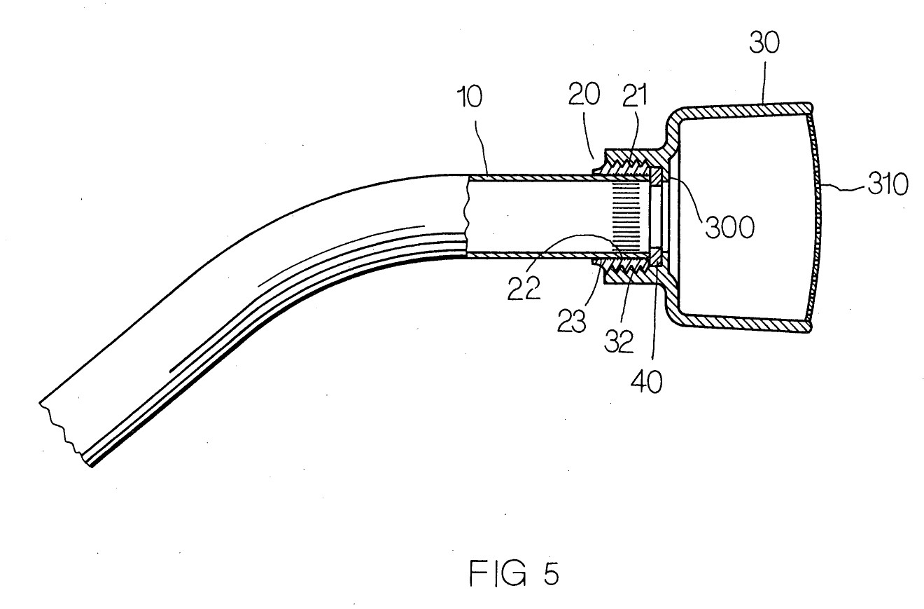

Referring to FIGS. 1 to 5, the water sprayer assembly of the present invention comprises a sprayer head 30 which has a first end which includes a section of threaded inner periphery 32 and a flange 300 extends inward from an inner periphery of the first end of the sprayer head 30. A plate 31 is connected to a second end of the sprayer head 30 and includes a plurality of holes 310 so that water flows through the holes 310.

A threaded fitting 20 has a threaded outer periphery 21 and a passage is defined therethrough. A first end of the threaded fitting 20 has an enlarged-first end 23. The passage has a section of knurl surface 22 defined in an inner periphery thereof and the knurl surface 22 is made in cruciform pattern. The threaded fitting 20 is connected to the first end of the sprayer head 30 by engaging the threaded outer periphery 21 of the threaded fitting 20 with the threaded inner periphery 32 of the sprayer head 30. A seal 40 is sandwiched between the flange 300 and the first end of the pipe 10 so as to prevent from leakage.

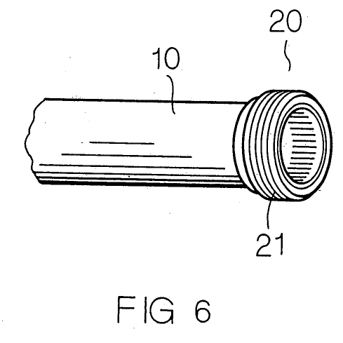

An aluminum pipe 10 has a first end extending through the passage of the threaded fitting 20 from the enlarged first end and being in flush with a second end of the threaded fitting 20 as shown in FIG. 6. The enlarged first end of the threaded fitting 20 allows the user to easily to insert the pipe 10 through the threaded fitting 20. An inner diameter of the passage at the section of the knurl surface 22 is slightly smaller than an outer diameter of the pipe 10 and a tool (not shown) is used to slight enlarge the first end of the pipe 10 so that an outer surface of the pipe 10 is securely pressed on the knurl surface 22 of the threaded fitting 20. By the connection, the pipe 10 is securely connected to the threaded fitting 20 and improves the shortcoming of the conventional connection of the threaded fitting and the pipe as mentioned above.

While we have shown and described the embodiment in accordance with the present invention, it should be clear to those skilled in the art that further embodiments may be made without departing from the scope of the present invention.

1. A water sprayer assembly comprising:
a sprayer head having a first end which includes a section of threaded inner periphery and a flange extending inward from an inner periphery of the first end of the sprayer head;
a threaded fitting having a threaded outer periphery and a passage defined therethrough, a first end of the threaded fitting having an enlarged first end, the passage having a section of knurl surface defined in an inner periphery of the passage, the threaded fitting connected to the first end of the sprayer head by engaging the threaded outer periphery with the threaded inner periphery, and
a pipe having a first end extending through the passage of the threaded fitting from the enlarged first end and being in flush with a second end of the threaded fitting, an outer surface of the pipe being securely pressed on the knurl surface of the threaded fitting.

2. The assembly as claimed in claim 1 further comprising a seal sandwiched between the flange and the first end of the pipe.

3. The assembly as claimed in claim 1, wherein an inner diameter of the inner periphery of the passage at the section of the knurl surface is smaller than an outer diameter of the pipe.

4. The assembly as claimed in claim 1, wherein the knurl surface is in cruciform pattern.
